(19) United States
(12) Patent Application Publication
(10) Pub. No.: US 2007/0169067 A1
(43) Pub. Date: Jul. 19, 2007

(54) Class library footprint file and java application authentication method using the same

(75) Inventors: Jung-jin Kim, Uiwang-si (KR); Jin-byun Kim, Seongnam-si (KR); Jung-ho Lee, Yongin-si (KR); Eun-su Jang, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/592,309

(22) Filed: Nov. 3, 2006

Related U.S. Application Data
(60) Provisional application No. 60/733,258, filed on Nov. 4, 2005.

(30) Foreign Application Priority Data
Feb. 16, 2006 (KR) 10-2006-0015152

(51) Int. Cl. G06F 9/44

(52) U.S. Cl. 717/163; 717/162

(57) ABSTRACT

A class library footprint file for authenticating a dynamically loaded class library during the execution of a JAVA application and a JAVA application authentication method using the class library footprint file are provided. The class library footprint file includes: authentication information for verifying the integrity of one or more class libraries used by the JAVA application before the JAVA application is executed. A list of class libraries to be authenticated is provided, in advance, to a JAVA application.

This application claims priority from U.S. Patent Application No. 60/733,258, filed on Nov. 4, 2005, in the United States Patent and Trademark Office and Korean Patent Application No. 10-2006-0015152, filed on Feb. 16, 2006, in the Korean Intellectual Property Office, the disclosures of which are incorporated herein in their entirety by reference.

### BACKGROUND OF THE INVENTION

1. Field of the Invention

The present invention relates to an authentication of a JAVA application, and more particularly, to a class library footprint file for authenticating a dynamically loaded class library during the execution of a JAVA application and a JAVA application authentication method using the same.

2. Description of the Related Art

JAVA applications are widely used by content providers to provide users with various interactive services in the fields of broadcasting or storage. A variety of JAVA application authentication methods have been suggested to allow users to securely execute JAVA applications provided by content providers.

Content providers or hosts distribute a signed JAVA application to users according to a specific transfer algorithm. A conventional JAVA application authentication method comprises using a JAVA manifest file including a list of digest values, a signature file of the JAVA manifest file, and a signature block file to authenticate validity of a signature of the signature file.

FIG. 1 is a flowchart of a related art JAVA application authentication method. A JAVA manifest file, a signature file, and a signature block file are used to authenticate a signed JAVA application.

FIG. 2 is a section of computer code of a manifest file included in a JAVA application. Referring to FIG. 2, a location and a digest value 201 of each class included in each JAVA archive (JAR) file is recorded in the manifest file.

Referring to FIG. 1, when a user requests to execute the signed JAVA application, the signed JAVA application is started (Operation 100). Then, the signed JAVA application is loaded (Operation 102). An attempt is made to load a class file required by the signed JAVA application (Operation 104). However, the class file must be authenticated before being loaded. The authentication process will now be described with reference to Operations 106 through 118.

Information on the class file to be loaded is obtained from a manifest file included in the signed JAVA application (Operation 106). Then, it is determined whether a digest value of the class file is correct (Operation 108). If it is determined that the digest value of the class file is not correct, authentication of the class file fails, and the signed JAVA application cannot use the class file (Operation 120).

If it is determined that the digest value of the class file is correct, information on a signature file included in the signed JAVA application is obtained (Operation 110). Integrity of the manifest file is verified by using the information on the signature file. If a digest value of the manifest file is not correct (Operation 112), authentication of the manifest file fails, and the signed JAVA application cannot use the class file (Operation 120).

If the digest value of the manifest file is correct (Operation 112), information on the signature block file included in the signed JAVA application is obtained (Operation 114). Then, it is determined whether a signature of the signature file is correct by using the information on the signature block file in order to verify the validity of the signature of the signed JAVA application (Operation 116). If the signature of the signed JAVA application is valid, the authentication of the signed JAVA application is complete and the signed JAVA application can use the class file (Operation 118). The authentication process is performed whenever an attempt is made to load class files required by the signed JAVA application.

The authentication of the signed JAVA application means that the content provider guarantees the integrity of all libraries used by the JAVA application. However, according to the conventional JAVA application authentication method, the authentication process is performed whenever class files used by the JAVA application are loaded. Therefore, the authentication process is redundantly performed, which is an ineffective use of time. Furthermore, if authentication of a class file fails during the execution of the JAVA application, causing an expected result, the execution of the JAVA application is aborted. In this case, the user has no way of knowing why the JAVA application has been aborted.

Also, since the JAVA application dynamically loads libraries, even when the authentication process is only performed once, an unauthenticated library, e.g., a class file or a data file, may be loaded during the execution of the authenticated JAVA application, which is not anticipated by the content provider.

### SUMMARY OF THE INVENTION

The present invention provides a class library footprint file that improves authentication processes of various devices downloading a JAVA application and guarantees reliable authentication of the JAVA application and a JAVA application authentication method using the class library footprint file.

According to an aspect of the present invention, there is provided a class library footprint file which authenticates a JAVA application comprising authentication information for verifying the integrity of at least one class library used by the JAVA application before the JAVA application is executed.

The class library footprint file further includes signature information of the class library footprint file.

The authentication information for verifying the integrity of at least one class library may comprise a digest value of each of the at least one class library.

According to another aspect of the present invention, there is provided a method of authenticating a JAVA application comprising: obtaining authentication information included in a class library footprint file of the JAVA application before the JAVA application is executed; verifying the integrity of at least one class library used by the JAVA application based on the obtained authentication information; and executing the JAVA application after the integrity of the at least one class library is verified.

The method may further include: determining whether a signature of the class library footprint file is valid based on the obtained authentication information, wherein the integrity of the at least one class library is verified only if it is determined that the signature of the class library footprint file is valid.

The authentication information included in the class library footprint file may include signature information of the class library footprint file, a list of class libraries used by the JAVA application, and a digest value of each of the class libraries.

The method may further comprise: verifying the integrity of a manifest file included in the JAVA application by using a signature file of the JAVA application; and determining, if the integrity of the manifest file is verified, whether a signature of the JAVA application is valid based on a signature block file of the JAVA application, wherein the JAVA application is executed only if it is determined that the signature of the JAVA application is valid.

### BRIEF DESCRIPTION OF THE DRAWINGS

The above and other aspects of the present invention will become more apparent by describing in detail exemplary embodiments thereof with reference to the attached drawings in which:

FIG. 1 is a flowchart illustrating a related JAVA application authentication method;

FIG. 2 is a section of computer code of a manifest file included in a JAVA application;

FIG. 3 is a block diagram illustrating a structure of a class library footprint file for authenticating a JAVA application according to an exemplary embodiment of the present invention;

FIG. 4 is a section of computer code of a class library footprint file according to an exemplary embodiment of the present invention;

FIG. 5 is a flowchart illustrating a method of manufacturing a JAVA application according to an exemplary embodiment of the present invention;

FIG. 6 is a flowchart illustrating a JAVA application authentication method using a class library footprint file according to an exemplary embodiment of the present invention; and

FIG. 7 is a flowchart illustrating a JAVA application authentication method using a class library footprint file according to another exemplary embodiment of the present invention.

### DETAILED DESCRIPTION OF THE EXEMPLARY EMBODIMENTS OF THE INVENTION

Hereinafter, exemplary embodiments of the present invention will be described in detail with reference to the attached drawings.

FIG. 3 is a block diagram illustrating a structure of a class library footprint file 300 for authenticating a JAVA application according to an exemplary embodiment of the present invention. All JAVA applications have a class library footprint file, which includes authentication information for verifying the integrity of all class libraries to be used by the JAVA application before the JAVA application is executed.

Referring to FIG. 3, the class library footprint file 300 includes a list of class libraries and digest values 304 of the class libraries. The class library footprint file 300 may include signature information 302 for verifying the integrity of the class library footprint file 300.

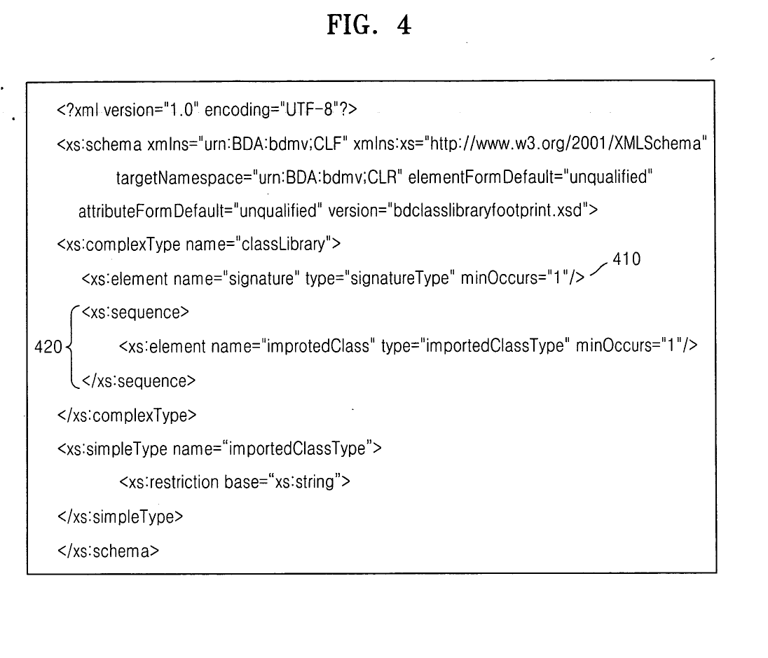

FIG. 4 is a section of computer code of a class library footprint file according to an exemplary embodiment of the present invention. Referring to FIG. 4, an XML Scheme of the class library footprint file includes a set of “importedClass” elements 420 and a “signature” element 410. The “importedClass” element 420 records information on a class library referred to by a class. The “signature” element 410 records a signature of a content provider corresponding to the class library footprint file.

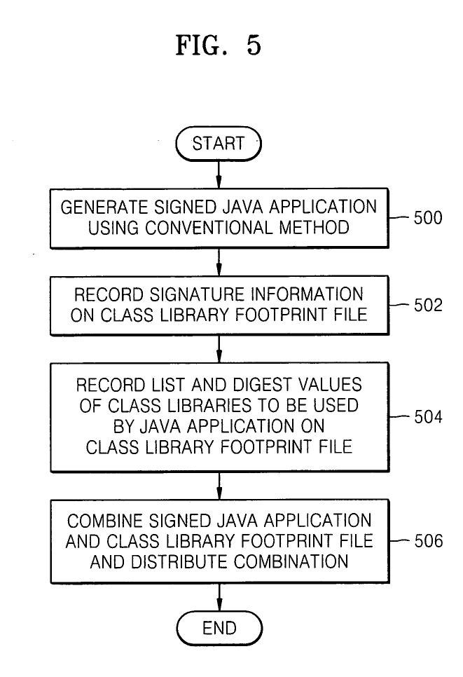

FIG. 5 is a flowchart illustrating a method of manufacturing a JAVA application according to an exemplary embodiment of the present invention. Referring to FIG. 5, a content provider generates a JAVA application, using a conventional method, according to the purpose of the JAVA application, and adds a signature to the JAVA application using a method of manufacturing a signed JAR suggested by a JAVA community (Operation 500). The content provider records signature information on a class library footprint file (Operation 502), and records names, locations, and digest values of class library files to be referred to by a class included in the JAVA application on the class library footprint file (Operation 504) in order to generate the class library footprint file. The content provider combines the class library footprint file and the signed JAVA application and distributes the combination to a user (Operation 506).

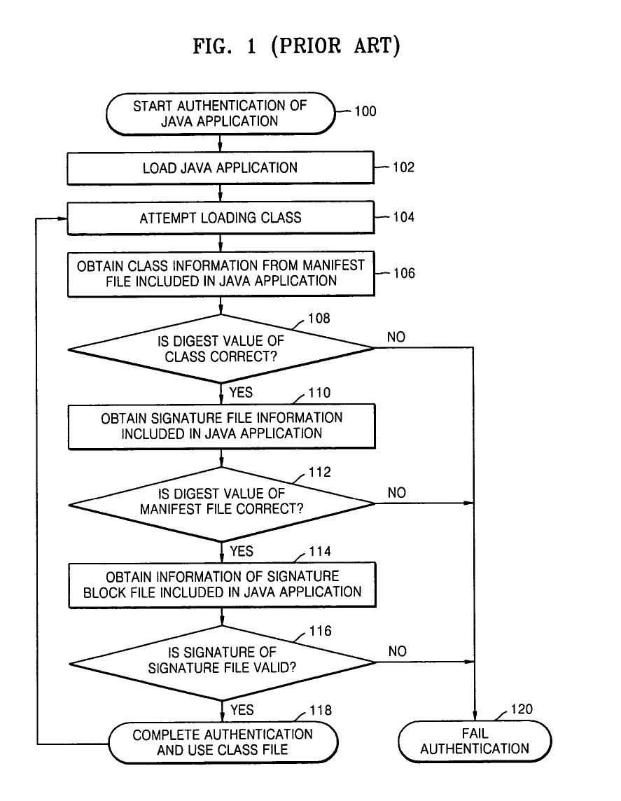

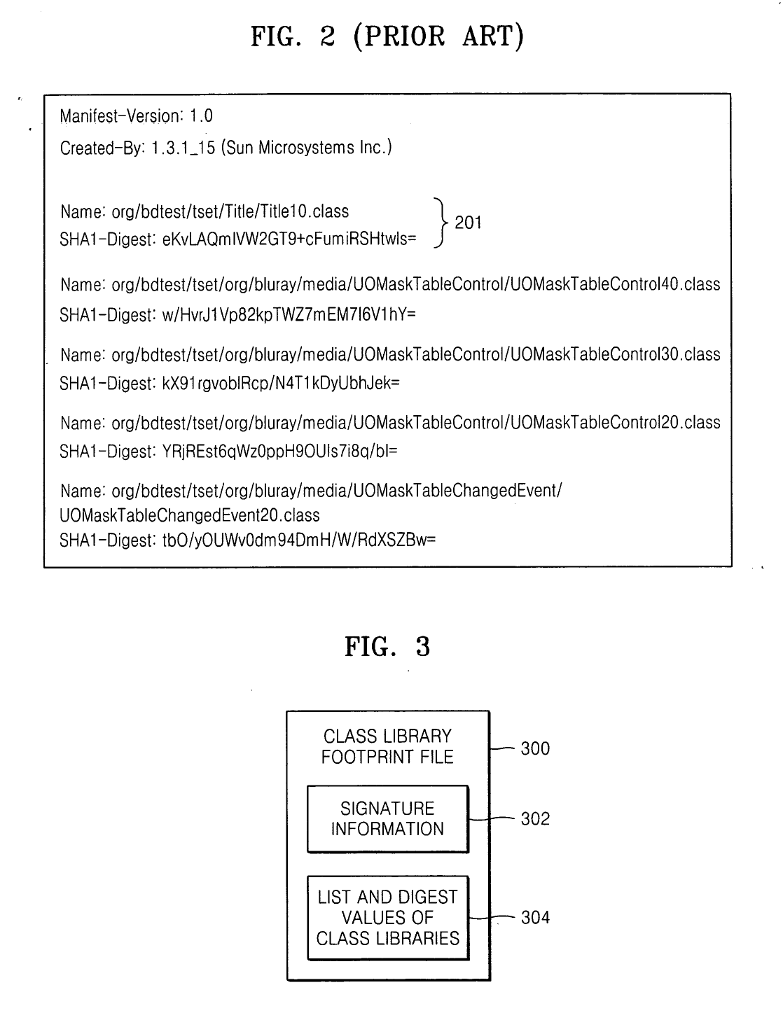

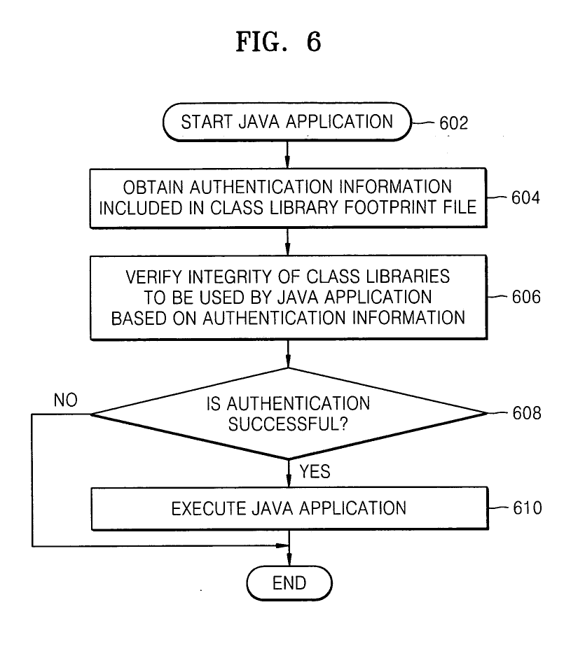

FIG. 6 is a flowchart illustrating a JAVA application authentication method using a class library footprint file according to an exemplary embodiment of the present invention. The JAVA application manufactured using the method illustrated in FIG. 5 is distributed to a user by the content provider or by a host according to a specific transfer algorithm. However, unlike the conventional method illustrated in FIG. 1, a JAVA engine completely authenticates class libraries before executing the JAVA application. Referring to FIG. 6, when the user requests to execute the signed JAVA application, the signed JAVA application is started (Operation 602).

Authentication information is obtained from the class library footprint file for authentication of the class libraries before the JAVA application is executed (Operation 604). The integrity of class libraries to be used by the JAVA application is verified based on the obtained authentication information (Operation 606). If authentication of the JAVA application by verifying the integrity of the class libraries is successful (Operation 608), the JAVA application is executed (Operation 610).

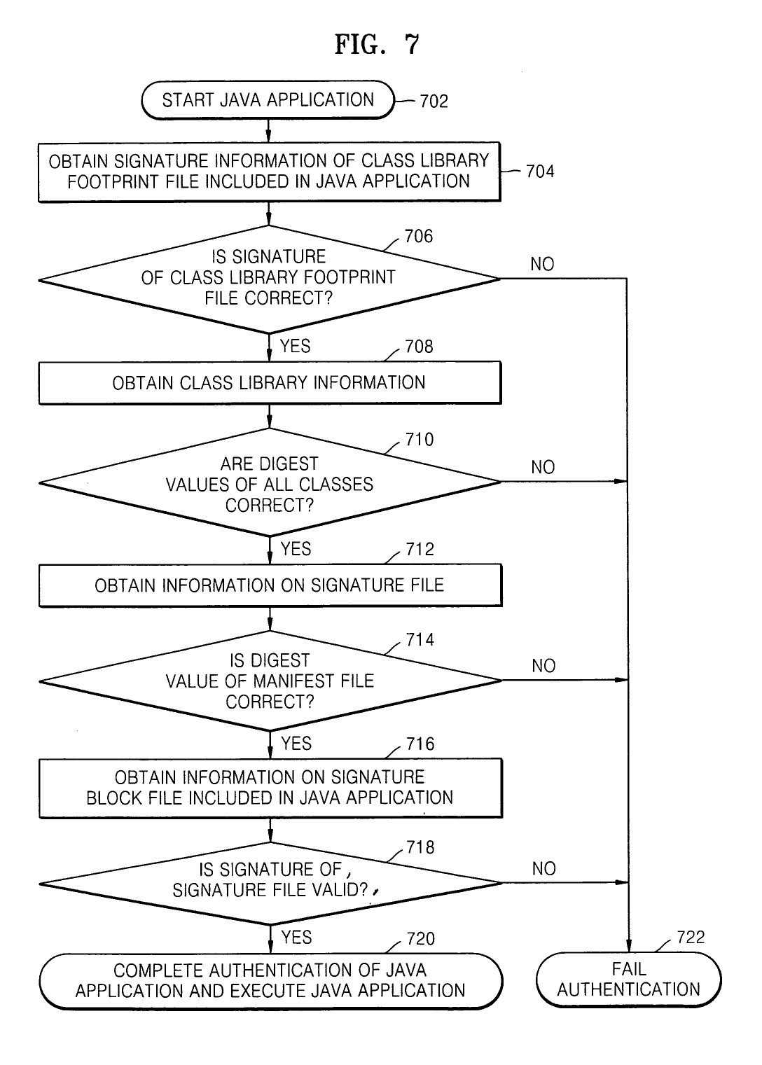

FIG. 7 is a flowchart illustrating a JAVA application authentication method using a class library footprint file according to another exemplary embodiment of the present invention. Referring to FIG. 7, after the user requests to execute the signed JAVA application, the signed JAVA application is started (Operation 702). Then signature information is obtained from authentication information of the class library footprint file included in the JAVA application (Operation 704) and validity of a signature of the class library footprint file is determined. If the signature of the class library footprint file is not valid (Operation 706), authentication of the JAVA application fails and the JAVA application is not executed (Operation 722).

If the signature of the class library footprint file is valid, class library information of the class library footprint file is obtained (Operation 708). It is determined whether all classes to be used by the JAVA application have correct digest values using the obtained class library information, and integrity of the class libraries is verified (Operation 710). If any class has an incorrect digest value, the authentication of the JAVA application fails and the JAVA application is not executed (Operation 722).

Information on a signature file included in the JAVA application is obtained (Operation 712). It is determined whether a digest value of a manifest file is correct based on the information of the signature file, and the integrity of the manifest file is verified (Operation 714). If the digest value of the JAVA manifest file is not correct, the authentication of the JAVA application fails and the JAVA application is not executed (Operation 722).

If the integrity of the manifest file is verified, information on a signature block file of the JAVA application is obtained (Operation 716). Then it is determined whether a signature of the signature file is correct based on the information on the signature block file, and the validity of the signature of the JAVA application is verified (Operation 718). If the signature of the signature file is not valid, the authentication of the JAVA application fails, and the JAVA application is not executed (Operation 722).

If the signature of the JAVA application is valid, the JAVA application is successfully authenticated and thus the JAVA application is executed (Operation 720).

The present invention can also be embodied as computer readable code on a computer readable recording medium.

According to an exemplary embodiment of the present invention, a list of class libraries to be authenticated is provided, in advance, to a JAVA application, which guarantees effectiveness and reliability of the authentication of the JAVA application.

The present invention overcomes a logical restriction of the conventional JAVA application authentication method that verifies a signature of a class when the class is dynamically loaded, or previously verifies signatures of non-specific class libraries, thereby increasing an authentication speed and performance of various devices.

The exemplary embodiments of the present invention improve feasible security of the conventional JAVA application authentication method, thereby improving security of the JAVA application for both a content user and a content provider, and securing reliable authentication of the JAVA application developed by the content provider, such that the JAVA application can guarantee service continuity.

As a result, the exemplary embodiments of the present invention address problems of various devices and services using a conventional JAVA application, thereby creating a more solid framework of the JAVA application.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A class library footprint file which authenticates a JAVA application comprising authentication information for verifying an integrity of at least one class library used by the JAVA application before the JAVA application is executed.

2. The class library footprint file of claim 1, further comprising signature information of the class library footprint file.

3. The class library footprint file of claim 1, wherein the authentication information for verifying the integrity of the at least one class library comprises a digest value of each of the at least one class library, and
wherein the authentication information for verifying the integrity of the at least one class library comprises a list of class libraries used by the JAVA application.

4. A method of authenticating a JAVA application comprising:
obtaining authentication information in a class library footprint file of the JAVA application before the JAVA application is executed;
verifying the integrity of at least one class library used by the JAVA application based on the obtained authentication information; and
executing the JAVA application after the integrity of the at least one class library is verified.

5. The method of claim 4, further comprising:
determining whether a signature of the class library footprint file is valid based on the obtained authentication information, and
wherein the integrity of the at least one class library is verified only if it is determined that the signature of the class library footprint file is valid.

6. The method of claim 5, wherein the authentication information of the class library footprint file comprises signature information of the class library footprint file, a list of class libraries used by the JAVA application, and a digest value of each of the at least one class library.

7. The method of claim 6, further comprising:
verifying the integrity of a manifest file included in the JAVA application by using a signature file of the JAVA application; and
determining, if the integrity of the manifest file is verified, whether a signature of the JAVA application is valid based on a signature block file of the JAVA application,
wherein the JAVA application is executed only if it is determined that the signature of the JAVA application is valid.
